(19) United States
(12) Patent Application Publication
(10) Pub. No.: US 2017/0006468 A1
(43) Pub. Date: Jan. 5, 2017

(54) COMMUNICATION CONTROL APPARATUS, COMMUNICATION CONTROL DRIVER, AND COMMUNICATION CONTROL METHOD

(71) Applicant: SEIKO EPSON CORPORATION, Tokyo (JP)

(72) Inventors: Tomoki TAKAHASHI, Sapporo-shi (JP); Naoki OSHIKAWA, Matsumoto-shi (JP)

(21) Appl. No.: 15/133,831

(22) Filed: Apr. 20, 2016

(30) Foreign Application Priority Data
Jul. 2, 2015 (JP) 2015-133887

(51) Int. Cl. H04W 8/22; H04W 4/00

(52) U.S. Cl. CPC H04W 8/22; H04W 4/001

(57) ABSTRACT

There is provided a communication control apparatus including: a device control section that controls a monitoring target device; and a communication resource maintaining section that includes communication resources for executing communication with the device, in which, if a trigger for starting to monitor the device is input, the device control section calls the communication resource, and monitors the device through communication with the device using the communication resources.

### BACKGROUND

1. Technical Field

The present invention relates to a communication control apparatus, a communication control driver, and a communication control method.

2. Related Art

The Version 4 printer driver (hereinafter, V4 printer driver) operated in Windows (registered trademark) which is provided by Microsoft corporation (registered trademark) is known as an operating system (hereinafter, OS). In the V4 printer driver, a bidirectional communication technology, which is referred to as Bidirectional communication (hereinafter, Bidi), is used for a structure in which a specific state of a printer, such as an error of the printer, which occurs during printing, is monitored and a notification is provided to a user. The V4 printer driver includes an XML format file which is referred to as a Bidi schema and a Driver Event XML file.

The Bidi schema is described by associating a response value (Management Information Base (MIB) value or the like) from a printer with a value (Bidi value) which is handled by Bidi according to each connection format (TCP/IP connection, WSD connection, or the like) that is used between a printer and a control apparatus on which the V4 printer driver is mounted. In addition, the Driver Event XML file is described by associating a value which is handled by Bidi defined in the Bidi schema with an event occurrence condition or the like. With the above configuration, a structure is constructed in which an event (Driver Event) is generated according to the response value which changes depending on the state of the printer in Bidi. If an event is generated, a background task for executing a specific application is generated in the control apparatus, and thus it is possible to provide a notification (notification in a display format which is referred to as toast, badge, tile text, or the like) according to the type of the event by the background task.

In addition, a printing control apparatus (refer to JP-A-2014-71573) is known which performs printer monitoring using a function of a printer monitoring process included in the V4 printer driver.

Both the above-described Bidi schema and Driver Event XML file are text-based files, and thus conditional expressions and values, which can be described in the Bidi schema and the Driver Event XML file, are limited to text. In addition, although a basic operation expression of values for comparison can be described in the Driver Event XML file, it is difficult to analyze values included in complex data or to describe a conditional expression which is necessary to determine a condition depending on a difference in respective bit values. Therefore, in a case in which the response value from the printer is information (information which is difficult to be handled by Bidi) in a format which is difficult to be described in the Bidi schema and the Driver Event XML file, a problem occurs in that it is difficult to notify a user of the state of the printer under the above-described structure. In addition, such a problem is not solved in JP-A-2014-71573.

### SUMMARY

An advantage of some aspects of the invention is to provide a communication control apparatus, a communication control driver, and a communication control method which enable monitoring of a device to be accurately executed, even in a situation in which monitoring of the device according to a certain communication format is limited.

According to an aspect of the invention, there is provided a communication control apparatus including: a device control section that controls a monitoring target device; and a communication resource maintaining section that includes communication resources for executing communication with the device. If a trigger for starting to monitor the device is input, the device control section calls the communication resource, and monitors the device through communication with the device using the communication resources.

According to the configuration, the device control section calls the communication resource according to the input of the trigger for starting to monitor the device, and monitors the device through communication with the device using the communication resource. Therefore, it is possible to accurately monitor the device using the communication resource, even in a situation in which monitoring of the device through a certain communication format (for example, the Bidi) is limited.

In the aspect of the invention, if a trigger, which indicates change from an idle state to a driving state of the device, is input, the device control section may start one process which is executed by an operating system and may perform communication with the device using the communication resources in the process.

According to the configuration, a process for executing communication with the device using the communication resources starts at timing in which a monitoring target device is switched into a driving state, thereby realizing the monitoring of the device in the process.

In the aspect of the invention, the process may maintain information of a driver which realizes the call of the communication resources, and may cause the driver corresponding to the maintained information to execute a notification process to the outside based on a result of monitoring of the device.

According to the configuration, the process is associated with the driver which realizes the call of the communication resources, and thus it is possible to cause the driver to easily and accurately execute the notification process.

The technical gist of the invention is realized by an object other than the communication control apparatus. For example, a configuration is exemplified as the invention, that is, there is provided a communication control driver which causes a computer to communicate with a monitoring target device, in which the communication control driver realizes a function of, if a trigger for starting to monitor the device is input, calling communication resources, which are included in an application installed in the computer and used for executing the communication with the device, and monitoring the device through communication with the device using the communication resources. In addition, the invention may be realized in various categories such as a method (communication control method) including processes which are realized by the communication control driver and a computer-readable storage medium in which a communication control driver is stored.

### BRIEF DESCRIPTION OF THE DRAWINGS

The invention will be described with reference to the accompanying drawings, wherein like numbers reference like elements.

FIG. 1 is a block diagram illustrating an example of the configuration of a communication control apparatus.

FIG. 2 is a flowchart illustrating a device monitoring process.

FIG. 3 is a diagram illustrating a part of a description example of a Bidi schema.

### DESCRIPTION OF EXEMPLARY EMBODIMENTS

Hereinafter, an embodiment of the invention will be described with reference to the accompanying drawings.

### 1. Outline of Communication Control Apparatus:

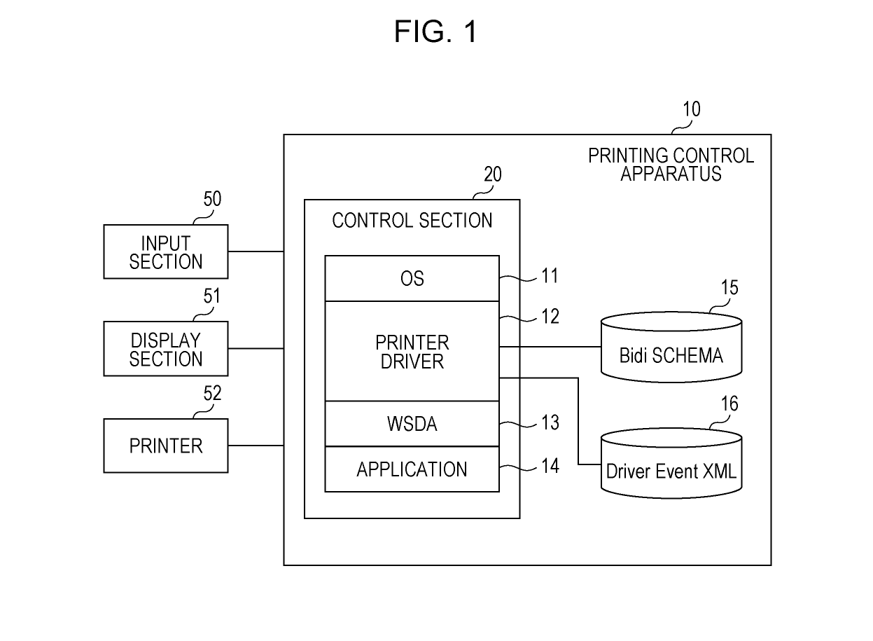

FIG. 1 is a block diagram illustrating an example of the configuration of a communication control apparatus according to the embodiment. A printing control apparatus 10 is an example of the communication control apparatus. The printing control apparatus 10 includes, for example, an IC, which includes a RAM, a ROM, a CPU, and the like, and a control section 20 which includes other storage media or the like. The control section 20 can execute a process according to programs (for example, a printer driver 12, a WSDA 13, an application 14, and the like) which are recorded in the ROM or another storage medium under an OS 11. Under the environment which is managed by the OS 11, the programs starting with a printer driver (hereinafter, driver) 12 which is one type of the V4 printer driver is installed. The driver 12 (a function of at least a part of the driver 12) corresponds to a communication control driver according to the invention. The OS 11 indicates an OS in which the V4 printer driver can operate, and Windows 8 may be used as an example. The WSDA is an abbreviation of Windows Store Device App, and is one type of application.

The printing control apparatus 10 includes an interface which is not shown in the drawing, and an input section 50, a display section 51, and a printer 52 are connected to the printing control apparatus 10 through the interface. The input section 50 is an input apparatus for receiving input manipulation of a user, and a mouse, keyboard, a touch panel, various input keys, and the like may correspond to the input section 50. The display section 51 is a display which displays an arbitrary image according to a signal which is output by the control section 20. The printer 52 is a printing apparatus which prints an image which is indicated by printing data based on the printing data which is output by the control section 20, and executes printing based on the printing data which is output by the control section 20 after rendering. The printer 52 is an example of a monitoring target device according to the embodiment.

The printing control apparatus 10 is realized by, for example, various apparatuses, such as a Personal Computer (PC), a tablet-type terminal, and a smart phone, which may be a control apparatus for the printer 52. In addition, the communication control apparatus according to the invention may be grasped by indicating a part of the configuration included in the printing control apparatus 10 (configuration which includes at least the control section 20). The printing control apparatus 10, the input section 50, and the display section 51 may be products which are independent from each other, or may be one product which is formed integrally.

### 2. Device Monitoring Process:

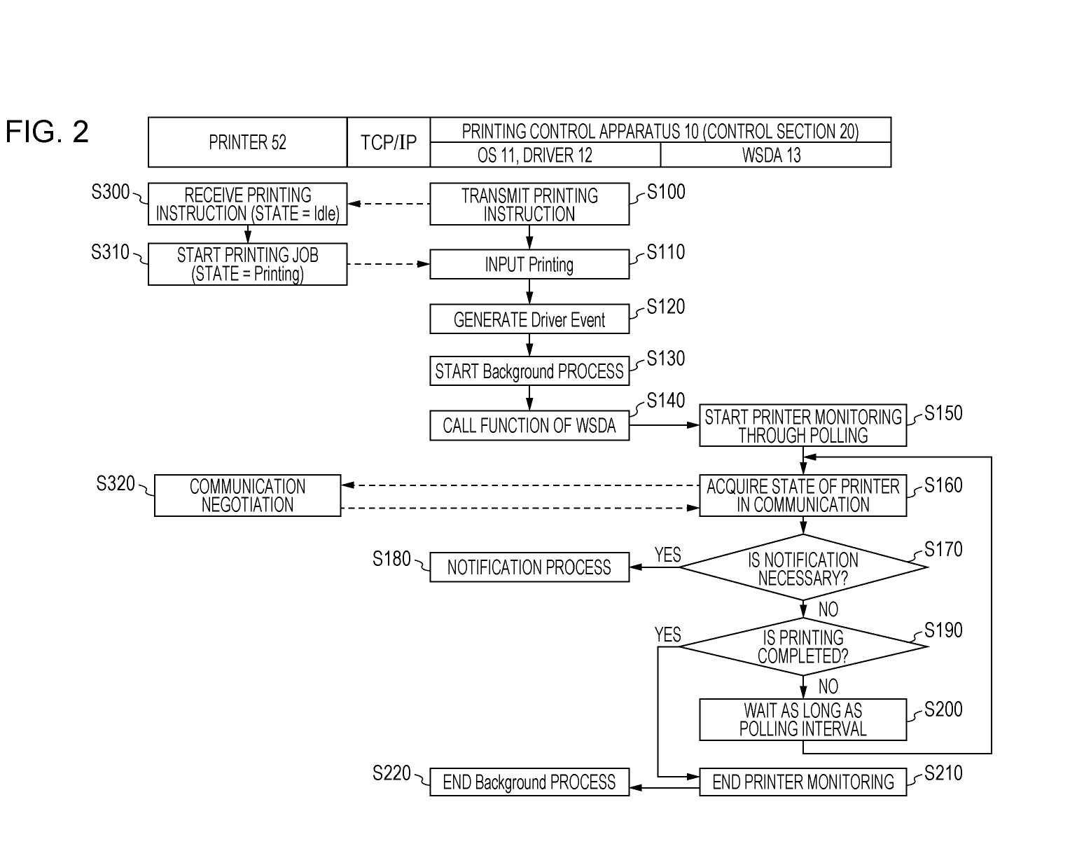

FIG. 2 illustrates a device monitoring process according to the embodiment using a flowchart. The flowchart is mainly realized in such a way that the control section 20 cooperates with the OS 11, the driver 12, and the WSDA 13. For convenience of explanation, the flowchart includes a process on a side of the printer 52 which is a monitoring target. At least a part of the flowchart represents a communication control method according to the invention. FIG. 2 illustrates the correspondence relationship between each step of the flowchart and any one of the printer 52, the OS 11, the driver 12, and the WSDA 13 which realize each step. However, the correspondence relationship may not be accurately analyzed. In addition, here, it is assumed that Transmission Control Protocol/Internet Protocol (TCP/IP) is used as an interface which connects the printer 52 to the printing control apparatus 10.

In step S100, the control section 20 transmits a printing instruction for a printing target to the printer 52. Specifically, the control section 20 inputs an image file which indicates a printing target from the application 14, and generates printing data in a format, which can be printed by the printer 52, by executing predetermined rendering for the input image file. Furthermore, the printing instruction (printing job), which includes the printing data, is transmitted to the printer 52. The image file, which is input from the application 14 is, for example, an XML Paper Specification (XPS) file which is described according to XPS specification.

If the printer 52 receives the printing instruction (printing job) in an idle state (step S300), the printer 52 starts a process of the received printing job (step S310). That is, printing starts based on the printing data by the printer 52. In addition, in step S310, the printer 52 transmits an MIB value indicative of a current state of the printer 52 to the printing control apparatus 10. If the printer 52 starts the process of the printing job, the state is changed from an idle state (Idle) into a driving state (Printing), and thus a predetermined MIB value indicative of the printing is transmitted to the printing control apparatus 10.

If the predetermined MIB value indicative of the printing is input from the printer 52 (step S110), the control section 20 generates a specific Driver Event according to the input (step S120). Specifically, the control section 20 converts the predetermined MIB value indicative of printing into a Bidi value by referring to the Bidi schema 15 (FIG. 1) which corresponds to TCP/IP connection and is maintained in advance. Furthermore, the control section 20 generates the specific Driver Event which is associated with the Bidi value by referring to a Driver Event XML file 16 (FIG. 1) which is maintained in advance. That is, in the embodiment, in a case in which the state of the printer 52 is “Printing”, the Bidi schema 15 and the Driver Event XML file 16 are described in advance such that the specific Driver Event is generated.

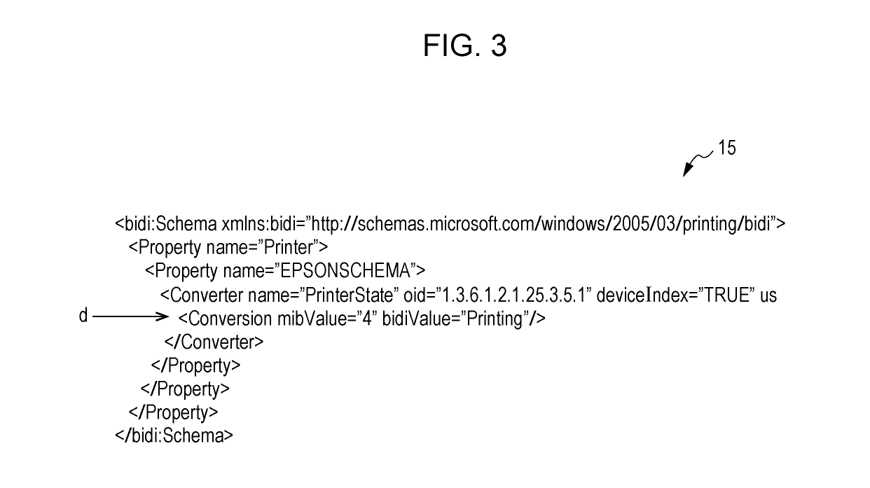

FIG. 3 is a diagram illustrating a part of a description example of the Bidi schema 15. In the example, Comversion mibValue=“4” bidiValue=“Printing”, which is indicated by reference symbol d in the description, means that, if the MIB value which is input from the printer 52 is “4”, the MIB value is converted into a Bidi value “Printing”. It can be said that a Bidi structure is used in the flow of steps S100, S300, S310, S110, and S120.

The control section 20 starts one Background process which is executed by the OS 11 with the occurrence of the specific Driver Event (step S130). Here, it is referred to as a background process as a meaning of a task or a process, which is performed in the background, in addition to a normal printing control process for the printer 52 by the driver 12.

The control section 20 calls a specific function included in the WSDA 13 in the started Background process (step S140). The function is an example of a communication resource for executing communication with a monitoring target device (printer 52). The function is one kind of a computer program, and describes a communication procedure and a determination reference which are necessary for monitoring the printer 52 which will be described later.

The control section 20 starts to monitor the printer 52 through polling according to the called function in the background process (step S150). The monitoring is realized by repeating a process in step S160 or the like, for example, every several seconds or dozens of seconds.

The control section 20 requests a state notification from the printer 52 through communication with the printer 52, and acquires the state notification from the printer 52 as a response to the request (step S160). The printer 52 executes communication negotiation with the control section 20 according to the request, and provides a notification of a current state of the printer 52 to the control section 20 (step S320). The communication (steps S160 and S320), which is executed with the printer 52 by the control section 20 according to the called function, is basically realized by transmitting and receiving, for example, an MIB value according to the universal Simple Network Management Protocol (SNMP) without using the Bidi structure in the V4 printer driver. Otherwise, the communication may be executed according to the function which is developed using a programming language such as so-called C.

The control section 20 determines whether or not it is necessary to provide notification to the user according to the state of the printer 52 which is acquired in step S160 (step S170). If it is necessary to provide notification, a process in step S180 is executed. If it is not necessary to provide notification, the process proceeds to determination performed in step S190. Determination reference acquired in step S170 is described in the communication resource included in the WSDA 13. For example, in a case in which the acquired state of the printer 52 corresponds to a predetermined error (ink exhaustion, paper exhaustion, paper jam, or the like) according to the determination reference, the control section 20 determines that it is necessary to provide notification.

In step S180, the control section 20 provides notification which is determined to be necessary in step S170. Here, the notification is visual notification through the display section 51 according to a known display format such as toast, badge, and tile text. For example, in a case in which it is determined that it is necessary to provide a notification of an error due to ink exhaustion in step S170, the control section 20 causes the display section 51 to perform toast-display (a kind of pop-up display) of the gist of ink exhaustion (step S180).

In contrast, in step S190, the control section 20 determines whether or not printing which is started by the printer 52 has ended. For example, in a case in which the control section 20 detects that the state of the printer 52 has been switched from Printing to Idle, the control section 20 determines that printing has ended. It is possible to detect the switching of the state of the printer 52 from Printing to Idle according to the Bidi structure. Otherwise, the control section 20 may decide the amount of time (time-out time) corresponding to time, which is sufficient to normally end printing, in advance, and may determine printing completion in a case in which the time-out time elapses from step S150.

In a case in which the control section 20 does not determine printing completion in step S190, the process proceeds to step S200. In a case in which the control section 20 determines printing completion, the process proceeds to step S210. In step S200, the control section 20 waits for an amount of time corresponding to a predetermined polling interval (for example, several seconds or dozens of seconds), and then repeats steps subsequent to step S160. In contrast, in step S210, the control section 20 ends the monitoring of the printer 52 which was started in step S150, and ends the Background process, which was continued subsequent to step S130, in step S220.

Here, because the control section 20 controls the drive (printing operation) of the printer 52 by executing the driver 12 under the management of the OS 11, it may be said that the control section 20 functions as a device control section for controlling a monitoring target device (printer 52). In addition, because the control section 20 includes the WSDA 13, it may be said that the control section 20 functions as a communication resource maintaining section which includes a communication resource for executing communication with the device (printer 52). In addition, according to the description in steps S310, S110 to S160, and the like, it may be said that, if a trigger for starting the monitoring of the device (printer 52) is input, the control section 20 calls the communication resource and monitors the device (printer 52) through communication with the device (printer 52) using the communication resource. Here, the predetermined MIB value, which is input in step S110 and indicates the Printing, or the specific Driver Event, which is generated in step S120, corresponds to the concept of the trigger.

In addition, according to the description of steps S310, S110 to S160, and the like, it may be said that, if the trigger is input, the control section 20 starts one process (Background process) which is executed by the OS 11, and performs communication with the device (printer 52) using the communication resource in the process. Meanwhile, according to FIG. 2, it is possible to perform interpretation such that, in the Background process which is started in step S130, the WSDA 13 executes the processes in steps S150 to S170 and S190 to S210 after the driver 12 calls the function of the WSDA 13 in step S140. However, in actuality, in the Background process, the driver 12 mainly realizes the processes in steps S150 to S170 and S190 to S210 according to the function included in the WSDA 13.

### 3. Description of Advantage or the Like:

According to the embodiment, the control section 20 calls the communication resource which is included in the WSDA 13, and monitors the printer 52 through communication with the printer 52 using the communication resource in accordance with the input of a trigger for starting the monitoring of the printer 52 which is the control target. In a case in which a device is monitored using the Bidi structure, which is typically executed until now, and in a case in which the response value from the device is information (information which is difficult to handle by Bidi) in a format which is difficult to describe using the Bidi schema and the Driver Event XML file, there are restrictions with which it is difficult to acquire the state of the device and to provide a notification to the user. However, according to the embodiment, communication with the printer 52, which is executed according to the communication resource (the function which is called from the WSDA 13), is not affected by such restrictions, and thus it is possible to execute secure communication with the printer 52, to accurately monitor the state of the printer 52, and to provide a notification to the user. For example, if the communication resources are prepared using a programming language such as C#, the control section 20 can analyze and evaluate the communication resources, and can acquire the state of the device, even in a case in which the response value from the printer 52 is data or a bit value which is structured in a complicated manner.

In addition, according to the embodiment, as understood through description with reference to FIG. 2, the monitoring of the printer 52, which is executed in the Background process started in step S130, ends together with the end of printing performed by the printer 52, and the Background process ends. That is, if the monitoring process does not reside in the OS 11 and is executed only when the monitoring target device is being driven, it is possible to reduce the load of the control section 20. Meanwhile, the Background process, (the OS 11 which manages the process) which is started in step S130, automatically maintains the information of the driver 12 (driver which realizes the call of the communication resource of the WSDA 13 in step S140 in the Background process). Therefore, the Background process (OS 11 which manages the process) can cause the driver 12 corresponding to the maintained information to execute the notification process (step S180) to the outside based on the results of monitoring of the printer 52. That is, if the Background process is associated with the driver 12, which realizes the call of the communication resource, it is possible to cause the driver 12 to easily and securely execute the notification process.

Here, if it is possible to mount firmware, which is changed to a specification in which only information in a format, which can be described in the Bidi schema and the Driver Event XML file, is returned as a response value, on the printer 52, it is apparent that the above-described restrictions substantially disappear. However, the change of the firmware, which is mounted on the printer 52 that is circulated in the market in large quantity, in various specifications requires a lot of labor and costs from infinite users, thereby being hardly realized. The embodiment provides a structure which realizes communication with the printer 52 which may return a response value in a format other than the format, which can be described in the Bidi schema and the Driver Event XML file, using the communication resource of an additionally developed WSDA 13. Therefore, it is not necessary to change the firmware on the side of the printer 52 as described above, and it is possible to realize communication (communication for monitoring) which has a high degree of freedom and in which the printer 52 sufficiently utilizes various types of response values which can be returned.

In the description of FIG. 2, the interface which connects the printer 52 to the printing control apparatus 10 is applied to TCP/IP connection. However, in the embodiment, it is possible to apply the interface to various connection methods such as Universal Serial Bus (USB) connection and Web Service for Devices (WSD) connection. In addition, the monitoring target device by the communication control apparatus which is assumed in the embodiment is not limited to the printer, and may correspond to various devices, which are driven and controlled by a communication control apparatus in which a driver corresponding to Bidi is embedded.

The entire disclosure of Japanese Patent Application No. 2015-133887, filed Jul. 2, 2015 is expressly incorporated by reference herein.

What is claimed is:

1. A communication control apparatus comprising:
a device control section that controls a monitoring target device; and
a communication resource maintaining section that includes communication resources for executing communication with the device, and
wherein, if a trigger for starting to monitor the device is input, the device control section calls the communication resource, and monitors the device through communication with the device using the communication resources.

2. The communication control apparatus according to claim 1,
wherein, if a trigger, which indicates change from an idle state to a driving state of the device, is input, the device control section starts one process which is executed by an operating system and performs communication with the device using the communication resources in the process.

3. The communication control apparatus according to claim 2,
wherein the process maintains information of a driver which realizes the call of the communication resources, and causes the driver corresponding to the maintained information to execute a notification process to the outside based on a result of monitoring of the device.

4. A computer-readable recording medium storing a communication control driver that causes a computer to communicate with a monitoring target device,
wherein, if a trigger for starting to monitor the device is input, the communication control driver realizes a function of calling communication resources, which are included in an application installed in the computer and used for executing the communication with the device, and monitoring the device through communication with the device using the communication resources.

5. A communication control method which causes a computer to realize communication with a monitoring target device, the method comprising:
if a trigger for starting to monitor the device is input, calling communication resources, which are included in an application installed in the computer and used for executing the communication with the device, and monitoring the device through communication with the device using the communication resources.
